(19) United States
(12) Patent Application Publication
(10) Pub. No.: US 2008/0184358 A1
(43) Pub. Date: Jul. 31, 2008

(54) Ensuring trusted transactions with compromised customer machines

(75) Inventors: Nicholas Stamos, Belmont, MA (US); Dwayne A. Carson, Mendon, MA (US); John Paglierani, Lunenburg, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Verdasys, Inc.

(21) Appl. No.: 12/011,475

(22) Filed: Jan. 25, 2008

Related U.S. Application Data
(60) Provisional application No. 60/897,729, filed on Jan. 26, 2007.

(51) Int. Cl. H04L 9/00

(52) U.S. Cl. 726/11

(57) ABSTRACT

A trusted transaction architecture that provides security from a client side input device to a merchant server by installing a secure custom browser process on the client side computer via an ActiveX control or the equivalent. This Secure Browser Process (SBP) may then be inspected to ensure that no external codes exist in its application space, that no subsequently loaded Dynamic Link Library (DLL), or equivalent, has been tampered with or modified, that no Application Programming Interface (API) has been overwritten or redirected, and that no input device driver has been hooked by a digital signature. The SBP then creates a secure channel to the input device(s) that are used to enter data into the browser application, and creates a secure channel to the merchant's destination server to ensure that data cannot be intercepted, even on the client side computer.

### RELATED APPLICATION

This application claims the benefit of U.S. Provisional Application No. 60/897,729, filed on Jan. 26, 2007. The entire teachings of the above applications are incorporated herein by reference.

### BACKGROUND OF THE INVENTION

The present invention provides for trusted interactions between an end user and a website, such as one that may be run by a merchant, under an assumption that the end user (client side) has been compromised.

The Internet has provided a unprecedented convenience for executing transactions between merchants and their customers. However, the security of such transactions continues to be a very real concern. Key logging “Trojan horse” software continues to be one weapon of choice for criminals. McAfee® estimates that the number of key logging malware installations increased by 250% between 2004 and 2006, and the number of phishing attacks is estimated to have multiplied 100 fold during the same period of time.

On-line stock trading firms have recently been particularly hard hit by highly sophisticated organized crime groups, posting losses in the tens of millions of dollars. In one such scheme, rather than simply using key loggers to snatch bank account credentials of prospective marks, thieves target on-line brokerage accounts using hijacked accounts or fraudulently created dummy accounts. The criminals buy stock in small, little traded securities in a series of transactions over a period of several months. The trades artificially inflate the stock value, permitting the thieves to then dump the shares at a profit before the scam is detected. This “pump and dump” scheme has been targeted at customers of brand name web based security firms such as E-Trade® and others.

To date, brokerage houses have routinely covered customers losses out of their own pockets, and seek ways to install extra security measures. These security measures revolve mainly around the use of anti-fraud technology to enable them to spot suspicious trades more quickly. In another approach, the brokerage houses supply customers with hardware keys or “dongles” to enable so called “two-factor” authentication in the hope of removing the security risk posed by static login credentials.

### SUMMARY OF THE INVENTION

What is needed is a way to provide trusted transactions between an end user (client side computer) and a merchant website when the client side must be assumed to have been compromised by Trojans, key loggers, or other malware.

The present invention provides security from a client side user keyboard (or other input device) to a merchant server by coordinating the deployment of a number of techniques.

To provide trusted transactions, data flow from the keyboard to an application is secured end to end. Steps are taken to avoid using standard operating system avenues for obtaining user input. This requires accessing the keyboard (or other input device) hardware without passing through any standard operating system facility, such as normal operating system Application Programming Interfaces (APIs), that are well known to security thieves. In one embodiment, this can be accomplished using a custom keyboard driver or low-level keyboard monitor driver that connects directly to a keyboard miniport or keyboard class driver that is installed on the end user's machine. Other approaches are possible including, but not limited to, other persistent secure code injection schemes, such as the Digital Guardian® product from Verdasys® (the assignee of the present invention).

In addition to securing the data flow from the keyboard to the application, a secure web browser environment is provided. This may be implemented by installing a secure custom browser process on the local machine via an ActiveX control or equivalent. This Secure Browser Process (SBP) is then tested (inspected) to ensure that no external codes exist in its application space. To confirm this, the SBP validates whether any subsequently loaded Dynamic Link Library (DLL), or equivalent, has been tampered with or modified. The SBP may similarly determine whether any kernel APIs have been overwritten or redirected. A secure keyboard driver may also be checked to ensure that its loaded image is not hooked in any way via a digital signature, such as by a cryptograph hash (e.g. MD5, SHA1, etc). In this way, the system may ensure that it will receive input from its own secure keyboard driver. Once the environment is verified, the SBP then instantiates a secure browser object with external APIs being blocked and no browser plug-ins being loaded.

The SBP then creates a secure channel (proxy) to the input devices that are used to enter data into the application, and creates a secure channel (proxy) to the merchant's destination server to ensure that data cannot be intercepted, even on the local machine.

In this manner, a complete layer solution is provided through the use of a validated system loader, a system inspector, a secure input channel, a secure communication channel, a secure authentication system, and a secure browser environment.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram illustrating injecting a custom Dynamic Link Library (DLL) into an Internet browser.

FIG. 2 is a block diagram illustrating sending information from an injected DLL to a server.

FIG. 3 is a flow diagram illustrating a normal data flow from a keyboard, mouse, or other input device to an application.

FIG. 4 is a block diagram illustrating a data flow from a keyboard, mouse, or other input device to a secure browser process via secure input channels.

FIG. 5 is a high-level diagram illustrating a merchant webpage.

FIG. 6 is a high-level diagram illustrating a webpage with an embedded object referencing a Secure Browser Host (SBH) ActiveX control.

FIG. 7 is a high-level diagram illustrating initializing a Secure Browser Process (SBP).

FIG. 8 is a high-level diagram illustrating inspecting a Secure Browser Process (SBP) to provide security validation.

FIG. 9 is a high-level diagram illustrating initiating an embedded browser object.

FIG. 10 is a high-level diagram illustrating creating a secure input channel to input devices.

FIG. 11 is a high-level diagram illustrating creating a secure communications channel to a destination server.

FIG. 12 is a flow diagram illustrating a flow of communications in a standard communications architecture.

FIG. 13 is a flow diagram illustrating encrypting communications before being passed through standard operating system components.

FIG. 14 is a high-level diagram illustrating a trusted transactions architecture.

### DETAILED DESCRIPTION OF THE INVENTION

A description of example embodiments of the invention follows.

Several difficulties exist with current Trojan horse and spyware detection software, which were originally developed to control malicious software. These techniques typically look for file signatures that are already known, and then remove such threats as possible. They may also monitor data traffic that leaves a customer's computer, but if personal data is obfuscated they cannot detect it. These processes also require updates as new threats are found, and are not built on a preventative security or other defensive mechanism. They also cannot, alone, secure a data stream between a browser client and a server because no coordinated, corresponding server component exists.

Current browser architectures also exhibit inherent security problems. They were initially designed to display graphical web pages, and then later extended to support add-ons, allowing vendors to write custom applications within the browser architectures. Such custom applications were later enhanced to allow scripting languages to allow interaction, such as web-based applications. These evolved peace-meal, over time, rather than being designed in a secure manner from the beginning. For example, protocols such as Hyper-Text Transfer Protocol Secure (HTTPS) were designed to provide some aspects of security, such as protecting the end user from network wire “snooping” or “eavesdropping.” Other security enhancements focus on protecting the end user from rogue websites and scripting code, but are not directed at protecting web applications from compromised end user machines (computers).

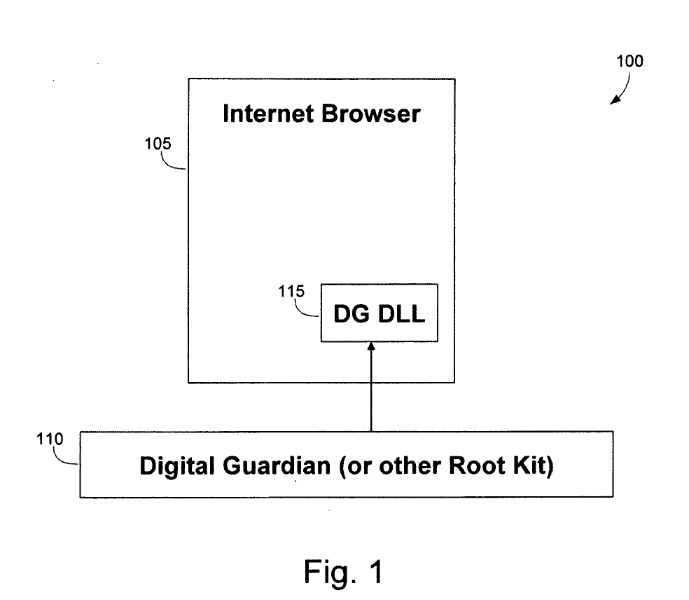

FIG. 1 is a block diagram 100 illustrating an example embodiment of the present invention, which is an improvement over simple Trojan detection methods. The example embodiment detects when an Internet browser 105, such as Microsoft's® Internet Explorer®, is launched and injects a custom Dynamic Link Library (DLL) 115 directly into the browser process 105. This can be instantiated as a Browser Helper Object (BHO) or other DLL module designed as a plug-in for the Internet browser 105.

Such BHOs, however, cannot alone provide complete security because they have unrestricted access to the Internet browser's event model; thus, forms of malware have also been created as BHOs. For example, the notorious “download.jact” exploit installed a BHO that activated upon detecting a secure HTTP connection to a financial institution, recorded a user's key strokes (intending to capture passwords), and then transmitted the information to a website operated by criminals. In response to these problems associated with BHO's, Internet browser providers later added add-on managers, such as with the release of Microsoft® Service Pack II for Windows XP®. This addition allowed the user to enable or disable installed BHOs, browser extensions, and ActiveX controls.

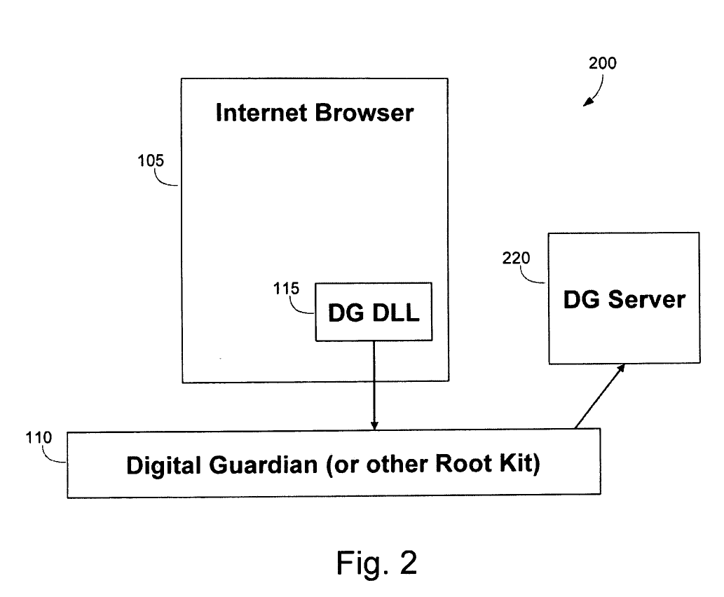

According to the example embodiment, a root kit 110 or other process, such as Digital Guardian® available from Verdasys® (the assignee of this patent application), is used to install a DLL 115 to enable examination of traffic flowing to and from the browser 105. The root kit 110 may use a central server 220, such as is illustrated in the example embodiment 200 of FIG. 2, to deploy and monitor an intelligent agent process. The agent process may then send information back to the server 220, such as usernames and passwords, over a HTTP connection. It should be noted that the information will not be visible to other processes because the agent process obfuscates the information before sending it to the server 220. The intelligent agent process may be used to log user data transactions and apply predefined roles to ensure not only the detection of end user data traffic, but also that data is being used properly. Such processes are also further described in U.S. patent application Ser. No. 10/995,020, filed Nov. 22, 2004, now published as U.S. Patent Publication 2006-0123101 entitled “Application Instrumentation and Monitoring,” assigned to Verdasys, Inc. (the assignee of the present invention), the entire contents of which are hereby incorporated by reference.

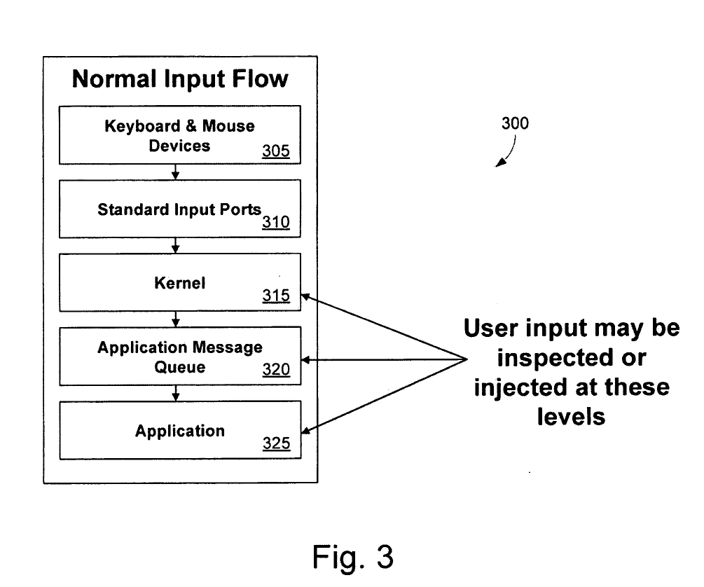

FIG. 3 is a flow diagram 300 illustrating the normal input flow of a standard communications architecture. In this standard architecture, user input, such as input from a keyboard, mouse, or other device 305, 310, can be inspected or rejected in several different places within the data flow of the standard architecture, such as at a kernel 315, application message queue 320, or application layer 325. Thus, in the standard architecture, there is no way to determine whether a received input message has actually originated at the user's keyboard or other input device 305, 310, and is not the result of a compromised system.

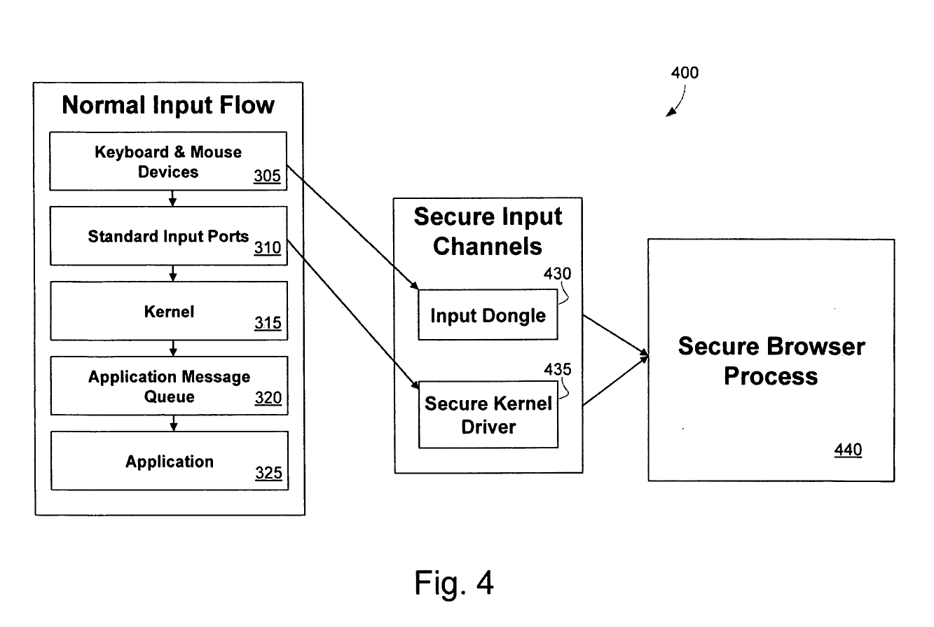

FIG. 4 is a block diagram 400 illustrating a data flow from a keyboard, mouse, or other input device 305, 310 through secure input channels 430, 435 to a secure browser process 440, according to an example embodiment of the present invention. In the example embodiment, the problems of the standard architecture are overcome by providing a custom, secure kernel driver that interfaces with a keyboard driver stack. The driver is loaded in such a way that it bypasses points 315, 320, 325 where user input can otherwise be compromised. This can be accomplished in the best mode by “short circuiting” normal operating system keyboard and mouse messaging processes, such as standard operating system Application Programming Interfaces (APIs), and instead providing a secure channel 430, 435 between the user input device 305, 310 and the secure browser process 440. The input stream coming from the secure keyboard driver and the secure browser process may be encrypted, such that, even if the user machine is compromised by malware, the keyboard traffic cannot be deciphered. The idea, in general, is to bypass the standard operating system components, and instead instantiate a custom secure input driver, the architecture of which is far less likely to be known or controllable by outsiders.

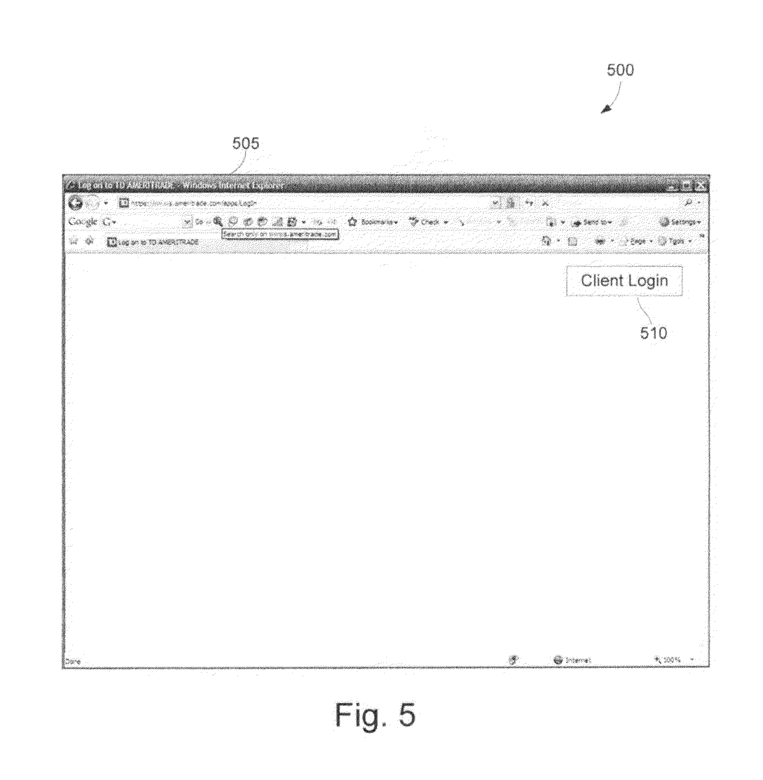

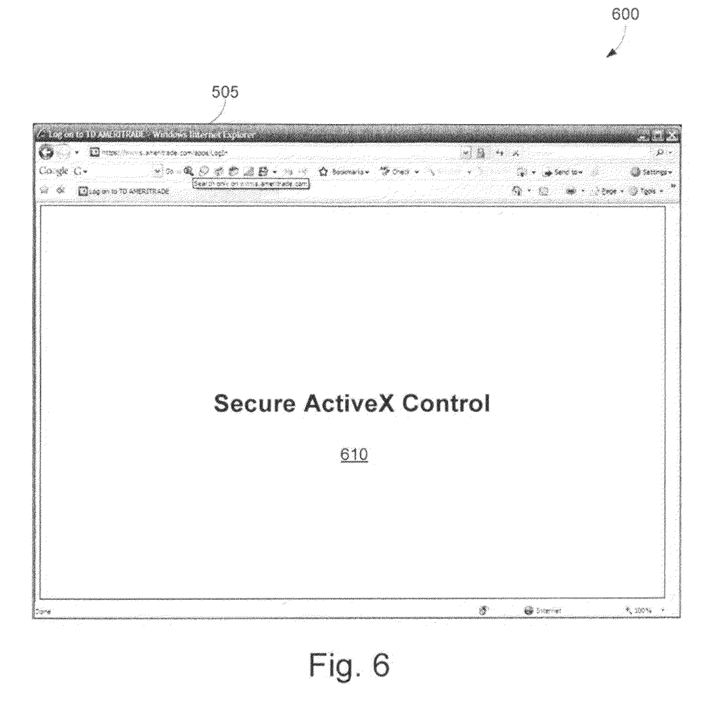

FIG. 5 is a high-level diagram 500 illustrating a merchant webpage and FIG. 6 is a high-level diagram 600 illustrating a webpage 505 with a single embedded object referencing a Secure Browser Host (SBH) ActiveX control 610. The process begins when a client of a merchant selects a login link 510 on the merchant's webpage 505, as illustrated in FIG. 5. Afterwards, as illustrated in FIG. 6, the process returns a webpage 505 from the host with a single embedded object referencing a Secure Browser Host (SBH) ActiveX control 610.

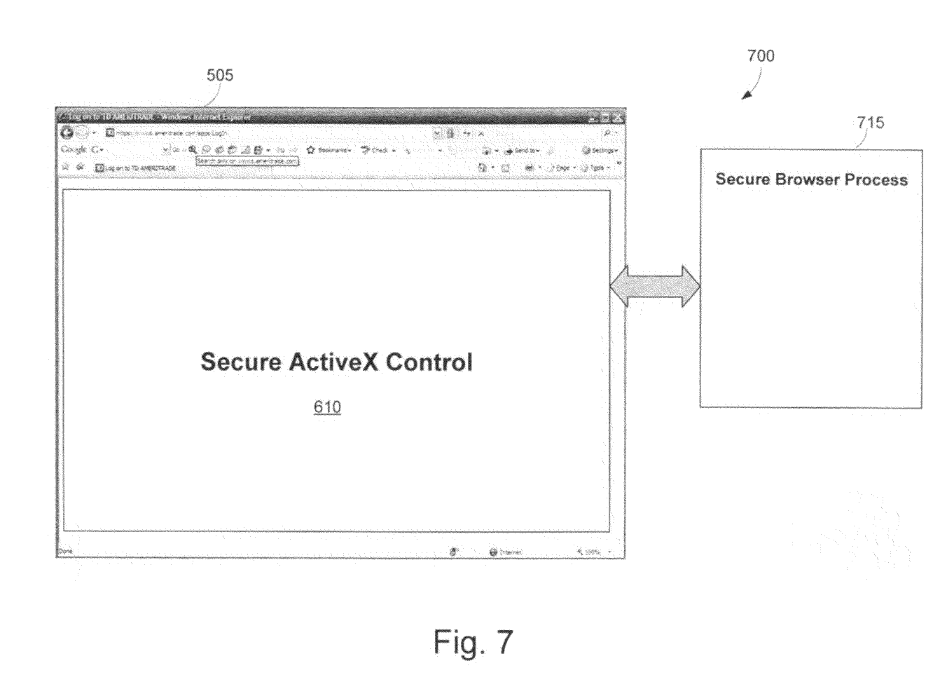

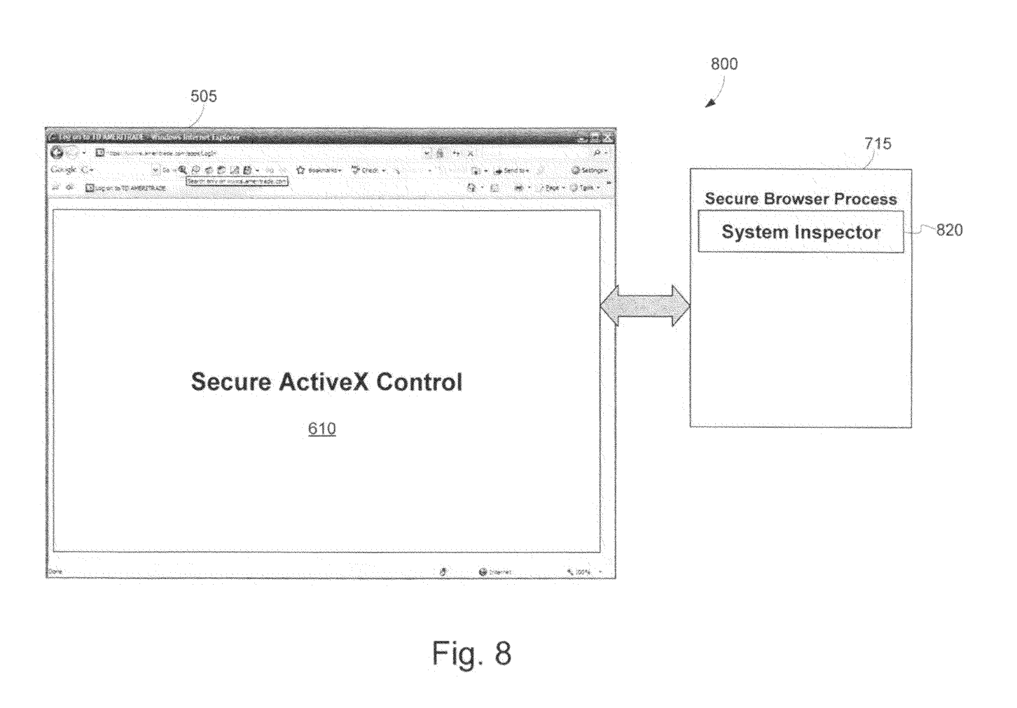

FIG. 7 is a high-level diagram 700 illustrating initializing a Secure Browser Process (SBP) 715. Upon return of the webpage 505 the ActiveX control 610 is initialized within the browser, which then launches a Secure Browser Process (SBP) 715 within the context of the original browser application. This SBP 715 is then tested to ensure that no external code exists in its application space using a “system inspector,” which is described in conjunction with FIG. 8.

FIG. 8 is a high-level diagram 800 illustrating inspecting the SBP 715 to provide security validation. Upon the launch of the SBP 715, the SBP 715 performs a “system inspector” function 820 to provide security validation. This system inspector function 820 validates all DLLs that are loaded into the process to ensure that they have not been tampered with or modified. In an alternate embodiment, a secure keyboard driver is also validated to ensure that its loaded image is not hooked in any way, such as via a digital signature (cryptograph hash, e.g. MD5, SHA1, etc). The SBP 715, thus, can be assured that it is only receiving input from its own secure keyboard driver. The SBP 715 may also validate that all kernel APIs that are in use have not been overwritten or redirected as part of the system inspector function 820. In the event that either the DLLs have been compromised or the kernel APIs or kernel drivers have been overwritten or modified, the process can then terminate or throw an exception.

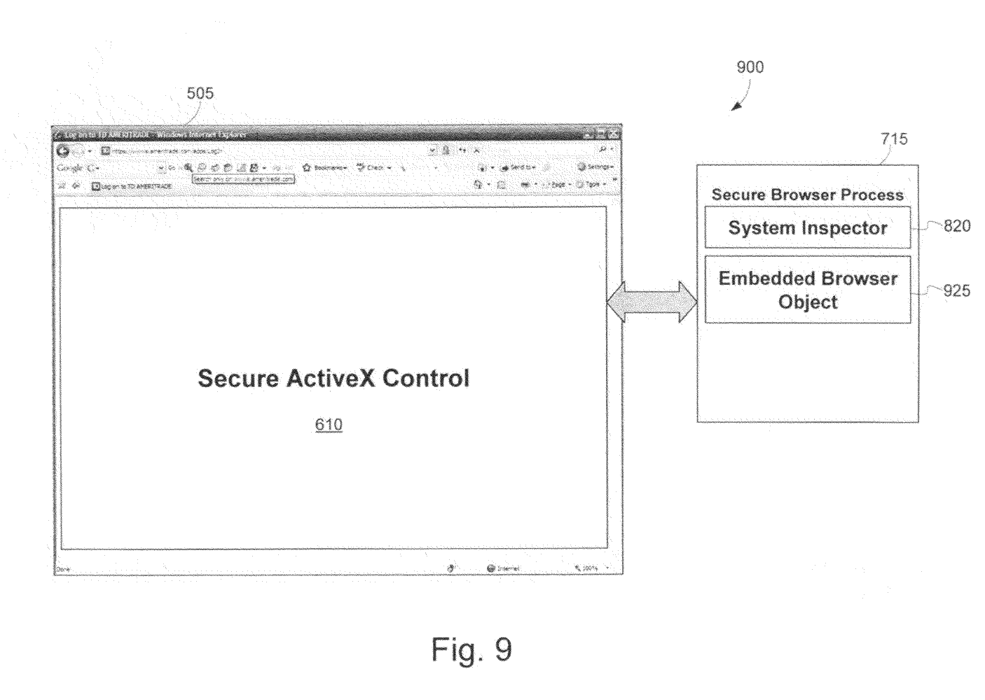

FIG. 9 is a high-level diagram 900 illustrating instantiating an embedded browser object 925 that blocks external APIs and plug-ins. Upon confirming that the environment is clean, the SBP 715 may then instantiate such an embedded browser object 925 with all external APIs being blocked, and no browser plug-ins being permitted to load.

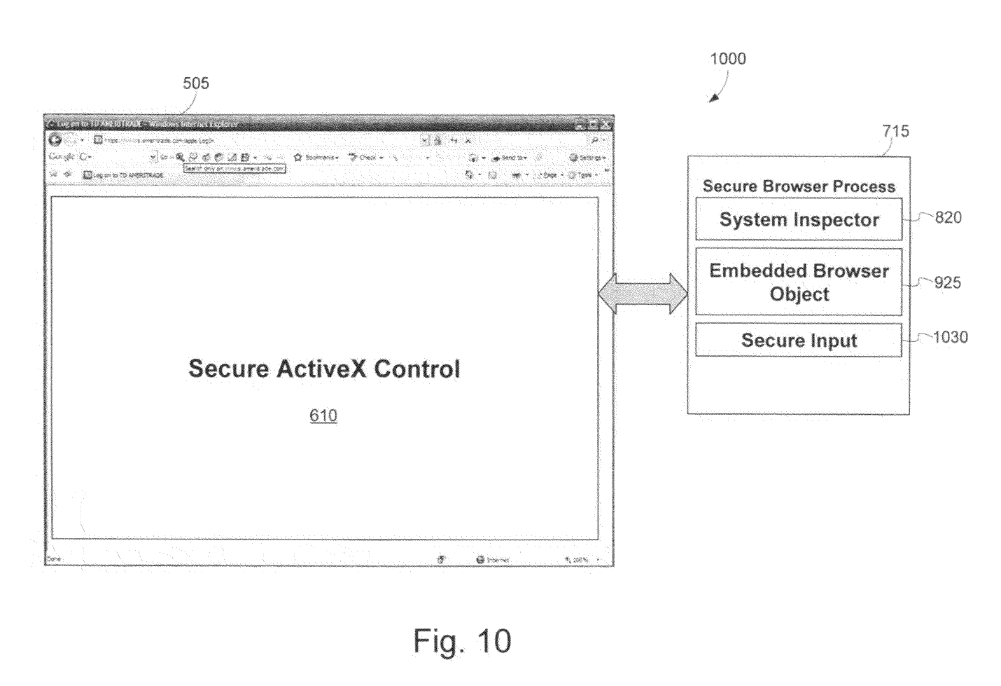

FIG. 10 is a high-level diagram 1000 illustrating creating a secure input channel 1030 to input devices. Upon confirming that the environment is clean, the SBP 715 can then open a secure channel 1030 (proxy) to the end user's input devices, such as a keyboard or mouse, which will be used in the process of entering data into the application.

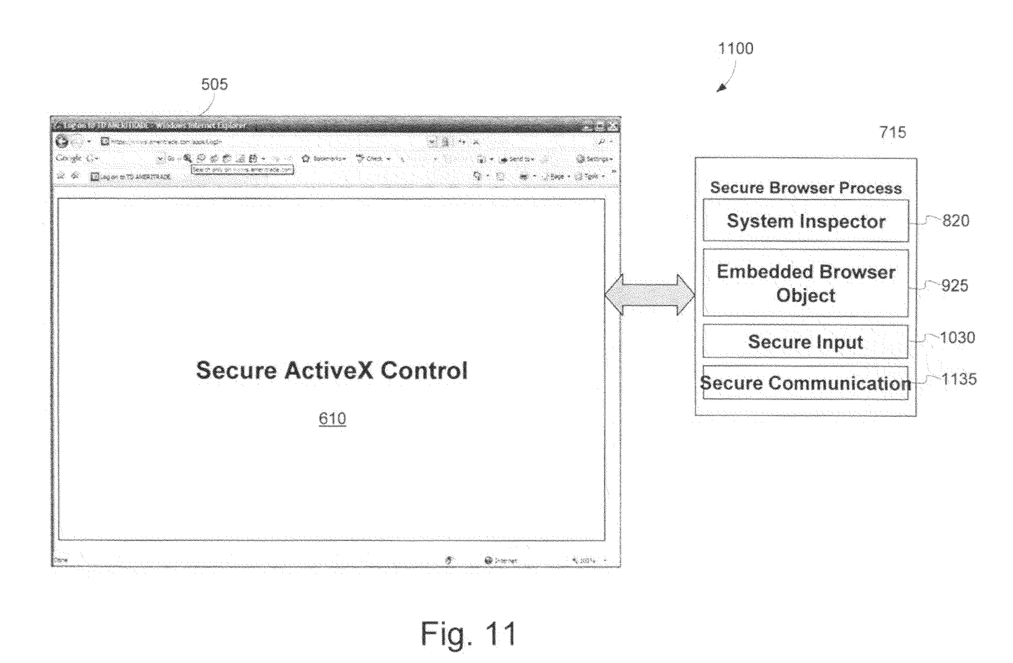

FIG. 11 is a high-level diagram 1100 illustrating creating a secure communications channel 1135 to the merchant's destination server. Upon confirming that the environment is clean, the SBP 715 also creates a secure channel 1135 (proxy) to the destination server. This architecture ensures that data cannot be intercepted and compromised, even on a local machine, because the connection between the keyboard and the destination server is secure.

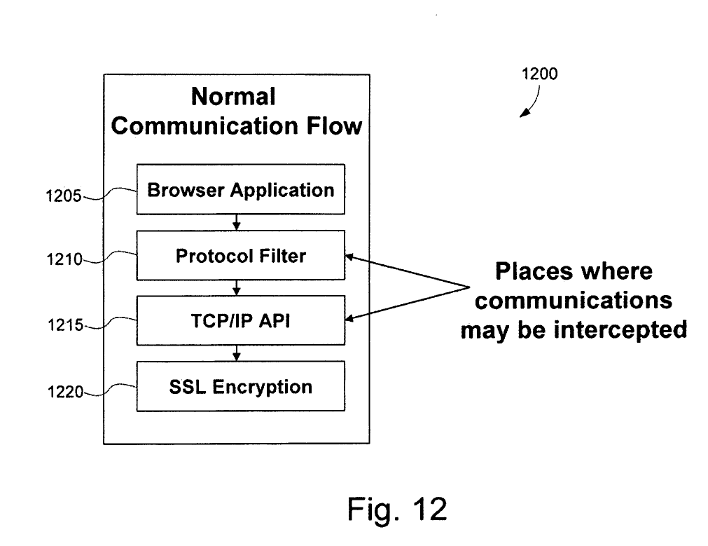

FIG. 12 is a flow diagram 1200 illustrating the flow of communications in a standard communications architecture. In the standard flow, communications originating from a browser application 1205, such as Transmission Control Protocol and Internet Protocol (TCP/IP) traffic, are completely clear until they reach a Secure Socket Layer (SSL) 1220, where they are then encrypted before being sent over a secure socket. In the standard architecture, it is possible for the communications to be intercepted between the browser process 1205 and the socket layer 1220 in intermediate components of the operating system, such as protocol filters 1210 or APIs 1215, because the communications are not encrypted until they reach the socket layer 1220.

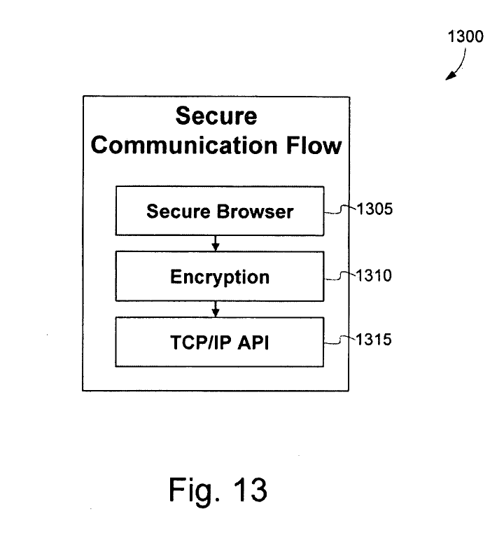

FIG. 13 is a flow diagram 1300 illustrating encrypting communications before being passed through standard operating system components, according to an example embodiment of the present invention. In the example embodiment, the problems of the standard communications architecture are overcome by encrypting 1310 communications originating from the browser process 1305 before they are sent through any other standard operating system components 1315, such as filters or APIs, where the communications may otherwise be seen in the clear. In this way, further security risks and possible interception points are minimized.

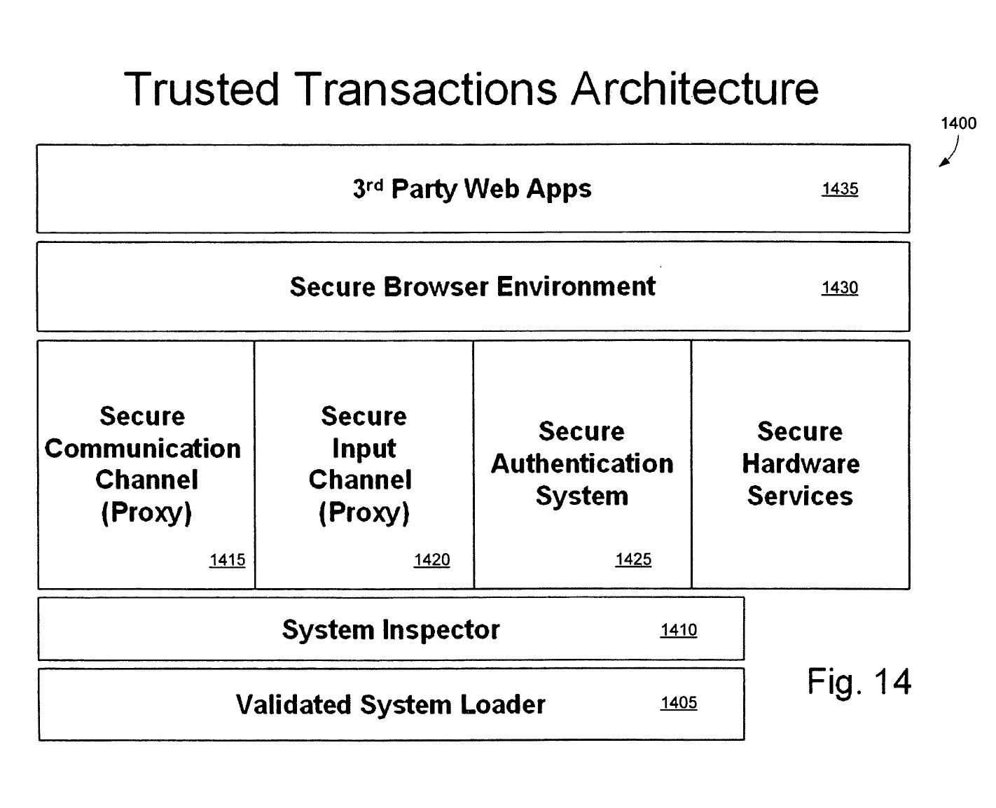

FIG. 14 is an high-level diagram 1400 illustrating the resulting trusted transaction architecture. At the bottom layer, a secure system loader 1405 is provided. In the context of the system loader 1405, a system inspector 1410 provides validation as described in connection with FIG. 8. Upon validation being established, a secure communication channel 1415, a secure input channel 1420, and a secure authentication system 1425 provide for trusted communication from “fingertip” user keyboard input to the destination server 1435 within the context of the secure browser environment 1430.

While this invention has been particularly shown and described with references to example embodiments thereof, it will be understood by those skilled in the art that various changes in form and details may be made therein without departing from the scope of the invention encompassed by the appended claims.

What is claimed is:

1. A system for providing trusted transactions, the system comprising:
a secure system loader to provide a secure browser process within a browser application;
a system inspector running within the secure system loader to provide security validation for the secure browser process; and
at least one secure input channel to provide trusted communication from a user input device to a destination server via the secure browser process.

2. A system as in claim 1 wherein the secure system loader installs a dynamic link library in the browser application.

3. A system as in claim 2 wherein the dynamic link library is a browser helper object.

4. A system as in claim 2 wherein the system inspector determines whether the dynamic link library loaded into the secure browser process has been modified.

5. A system as in claim 1 wherein the system inspector determines whether any kernel application programming interfaces have been modified.

6. A system as in claim 1 wherein the secure browser process encrypts communications before the communications become subject to standard operating system components.

7. A system as in claim 1 wherein the at least one secure channel includes a first secure channel between the user input device and the secure browser process, and a second secure channel between the secure browser process and the destination server.

8. A system as in claim 1 wherein the user input device is a keyboard.

9. A method for providing trusted transactions, the method comprising:
instantiating a secure browser process within a browser application;
inspecting components of the secure browser process to provide security validation for the secure browser process; and
creating at least one secure channel from a user input device to a destination server via the secure browser process.

10. A method as in claim 9 wherein instantiating the secure browser process includes installing a dynamic link library in the browser application.

11. A method as in claim 10 wherein the dynamic link library is a browser helper object.

12. A method as in claim 10 wherein inspecting components of the secure browser process includes determining whether the dynamic link library loaded into the secure browser process has been modified.

13. A method as in claim 9 wherein inspecting components of the secure browser process includes determining whether any kernel application programming interfaces have been modified.

14. A method as in claim 9 further including encrypting communications before the communications become subject to standard operating system components.

15. A method as in claim 9 wherein creating the at least one secure channel includes creating a first secure channel between the user input device and the secure browser process, and crating a second secure channel between the secure browser process and the destination server.

16. A method as in claim 9 wherein the user input device is a keyboard.

17. A computer readable medium having computer readable program codes embodied therein for providing trusted transactions, the computer readable medium program codes including instructions that, when executed by one or more processors, cause the processor(s) to individually or jointly:
instantiate a secure browser process within a browser application;
inspect components of the secure browser process to provide security validation for the secure browser process; and
create at least one secure channel from a user input device to a destination server via the secure browser process.

18. A computer readable medium as in claim 17 wherein the instructions that instantiate the secure browser process include instructions that install a dynamic link library in the browser application.

19. A computer readable medium as in claim 18 wherein the instructions that inspect components of the secure browser process include instructions that determine whether the dynamic link library loaded into the secure browser process has been modified

20. A computer readable medium as in claim 17 further including instructions that encrypt communications before the communications become subject to standard operating system components.

21. A computer readable medium as in claim 17 wherein the instructions that create the at least one secure channel include instructions that create a first secure channel between the user input device and the secure browser process, and instructions that create a second secure channel between the secure browser process and the destination server.
